(19) United States
(12) Patent Application Publication
(10) Pub. No.: US 2025/0079478 A1
(43) Pub. Date: Mar. 6, 2025

(54) BIPOLAR PLATE WITH AT LEAST ONE LAYER AND AT LEAST ONE INSERT

(71) Applicant: Reinz-Dichtungs-GmbH, Neu-Ulm (DE)

(72) Inventors: Andreas MICHALKE, Ulm (DE); Alexander TRIPPEL, Senden (DE); Maxim VOVCUK, Neu-Ulm (DE); Sina KAISER-KRUG, Ulm (DE); Andreas RUOPP, Merklingen (DE); Tobias WOLF, Neu-Ulm (DE); Hans WALDVOGEL, Krumbach (DE); Franz SCHWEIGGART, Pfaffenhofen (DE)

(21) Appl. No.: 18/814,057

(22) Filed: Aug. 23, 2024

(30) Foreign Application Priority Data
Sep. 6, 2023 (DE) 20 2023 105 128.6

(51) Int. Cl. H01M 8/0265; C25B 9/23; C25B 13/02; H01M 8/0276; H01M 8/0284; H01M 8/1004

(52) U.S. Cl. CPC H01M 8/0265; C25B 9/23; C25B 13/02; H01M 8/0276; H01M 8/0284; H01M 8/1004

(57) ABSTRACT

A bipolar plate for an electrochemical system comprising a layer and an insert. The layer comprises a through-opening and a flow field with an electrochemically active area. The insert comprises a fluid guide structure having a plurality of protrusions arranged between the flow field and the through-opening, so that fluid is guided from the through-opening through the fluid guide structure between the protrusions to the flow field or vice versa. The fluid guide structure comprises a first and second region arranged next to each other in the fluid flow direction, wherein the protrusions in the first region and in the second region each have different distances from one another and/or are arranged at different densities and/or are shaped differently, so that a flow cross-section is smaller in the first region than in the second region and/or a flow resistance is greater in the first region than in the second region.

### CROSS REFERENCE TO RELATED APPLICATION

The present application claims priority to German Utility Model Application No. 20 2023 105 128.6, entitled “BIPOLAR PLATE WITH AT LEAST ONE LAYER AND AT LEAST ONE INSERT”, filed Sep. 6, 2023. The entire contents of the above-identified application is hereby incorporated by reference for all purposes.

### TECHNICAL FIELD

The present disclosure relates to a bipolar plate for an electrochemical system, which has a layer and an insert. Furthermore, the present disclosure relates to an arrangement for an electrochemical system with the bipolar plate. Furthermore, the present disclosure relates to an electrochemical system comprising a plurality of stacked bipolar plates or a plurality of stacked arrangements.

### BACKGROUND AND SUMMARY

The electrochemical system in this document can be, for example, a fuel cell system, an electrochemical compressor, a redox flow battery or an electrolyser.

In general, electrochemical systems typically comprise a stack of single electrochemical cells, each having a plurality of layers including at least one bipolar plate and a membrane electrode assembly (MEA), each single cell being bounded by two adjacent bipolar plates. The stack of individual electrochemical cells can have two end plates that press the individual electrochemical cells together and give the stack stability. Furthermore, the electrochemical single cells can comprise gas diffusion layers (GDL) or porous transport layers (PTL), which are arranged between the bipolar plate and the membrane electrode assembly. The bipolar plate can fulfill several functions: indirect electrical contacting of electrodes of the membrane electrode assembly (MEA), separation of media such as water, oxygen or hydrogen and electrical connection of the neighboring electrochemical individual cells.

The bipolar plate comprises at least one through-opening (port) as an inlet or outlet for passing a fluid through the bipolar plate, a flow field with an electrochemically active region, and a fluid guide structure located therebetween for guiding the fluid between the through-opening and the flow field. In particular, the fluid guide structure can form a fluidic connection between the through-opening and the flow field. The fluid guide structure is often formed by several protrusions of the bipolar plate, so that there are respective passages between the neighboring protrusions, allowing the fluid to flow.

The bipolar plate can be single or multi-layered, for example. While bipolar plates in fuel cells are often double-layered so that cooling fluid can flow between the two individual layers, bipolar plates in electrolysers are usually single-layered. The bipolar plate itself and each layer of a bipolar plate can be regarded as a separator plate, as this causes a separation of media.

In addition to the aforementioned bipolar plates, MEA, GDL or PTL, other layers can also be provided. Cell frames and/or cell seals can be arranged between adjacent bipolar plates to seal the cells. The stack of individual electrochemical cells must be sealed off from an external space, as a fluid or medium inside the individual electrochemical cells is often under excess pressure compared to the external pressure. Depending on the type of electrochemical system, the fluid may include, for example, hydrogen, air (oxygen), water, cooling medium and/or mixture(s) thereof. In an electrolyser, the pressure difference between the environment and the inside of an electrochemical cell can even exceed 20 bar. For example, the pressure on the product side, for example the H₂ side, may be up to 40 bar, while the pressure on the reactant side, for example the H₂O side, is only up to 2 bar. It is therefore important to seal off the flow field of the fluid from the environment and also within the electrochemical system. For this purpose, the electrochemical system can have at least one cell frame running around the outer edge of the individual electrochemical cell for each of the individual electrochemical cells, particularly in electrolyser applications, in order to achieve a sealing effect. In addition, the electrochemical system can comprise one or more sealing layers or cell seals for each of the individual electrochemical cells in order to reinforce the sealing effect. The features of the present disclosure can also be applied in anionic exchange membrane electrolysis, for example in electrolysis of CO₂.

However, such conventional electrochemical systems have the following problems. The layer lying on the bipolar plate (i.e. cell frame or cell seal) crosses the passages of the fluid guide structure and is not supported by the bipolar plate in this region. When pressing the electrochemical cell, the layer in this region cannot transfer sufficient pressure or compression. On the other hand, the region of the fluid guide structure must be crossed in the case of a single-layer bipolar plate, as the anode side and the cathode side of the bipolar plate, in particular of an electrolyser, are made from a single sheet, i.e. they lie essentially congruently on top of each other during stacking or assembly and can only transmit the force required for sealing via the strength and/or rigidity of the cell frame and/or the cell seal itself. Due to the required electrical insulation, the cell frame and/or the cell seal are usually made of plastic, but this is often not strong and/or rigid enough, which can be problematic when pressing the stack. This is because deformations can occur in the direction of the passages at the points where the cell frame and/or the cell seal run across the fluid guide structure. The deformations often cause the sealing layer opposite the membrane and the cell frame and/or the cell seal to lose pressure. If the medium is introduced into the port, the medium then exits at the sealing layer. The loss of pressure leads to leakage, which can result in a short circuit or even a total failure of the system.

In order to address this problem, support elements are sometimes used in the prior art, which are arranged as a seal support bridge over the fluid guide structure molded into the bipolar plate, see for example publications DE 10 2014 202 775 A1 and DE 10 2020 215 014 A1.

There is a continuous need to further increase the tightness of the system, to prevent or at least reduce pressure loss or fluid loss and/or to increase the safety of the system.

The object of the present disclosure is therefore to provide a bipolar plate, an arrangement comprising the bipolar plate, and an electrochemical system comprising a plurality of the stacked bipolar plates or a plurality of the stacked arrangements, which at least partially solves the aforementioned problems.

According to a first aspect, a bipolar plate for an electrochemical system, in particular for an electrolyser, is provided. The bipolar plate comprises at least one layer and at least one insert. The layer comprises at least one through opening as an inlet or outlet for a fluid and a flow field with an electrochemically active region.

The insert is arranged at the through-opening and comprises a fluid guide structure for guiding the fluid. The fluid guide structure of the insert has several protrusions and is arranged in the flow direction of the fluid between the flow field and the through-opening, so that the fluid is guided or can flow from the through-opening through the fluid guide structure between the protrusions to the flow field or vice versa.

Here, the fluid guide structure has a first region and a second region, which are arranged next to one another in the direction of flow of the fluid, with the protrusions in the first region and in the second region each having different distances from one another and/or being arranged at different densities and/or being shaped differently, so that a flow cross-section in the first region is smaller than a flow cross-section in the second region and/or a flow resistance in the first region is greater than a flow resistance in the second region.

Due to the different flow cross-sections or flow resistances in the two regions of the fluid guide structure of the insert, the fluid volume and fluid velocity can be locally controlled, which can have a positive effect on the tightness of the system.

In addition, the flow can be optimized, which leads to a more uniform distribution of the fluid along the bipolar plate, which in turn has a positive effect on the tightness of the system. It has been found that the fluid flow is usually not constant with the same flow cross-sections or flow resistances along the fluid guide structure. This is often due to the components upstream or downstream of the fluid guide structure. If the through-opening is rectangular, for example, the flow at its corner regions is usually lower than at the elongated edge of the through-opening due to the increased flow resistance in these regions. The flow of the fluid can thus be homogenized by locally increasing the flow resistance of the fluid guide structure at the elongated edge of the through-opening. By homogenizing the fluid distribution, the sealing elements of the system can in turn be simplified and standardized. To compare the two regions, the regions of the fluid guide structure should be selected so that they have the same lateral width transverse to the direction of flow.

The fluid guide structure of the insert often has several passages, each of which extends between adjacent protrusions and is designed to guide the fluid along the layer. It may be provided that at least two of the passages have a different flow cross-section and/or a different flow resistance and/or a different width and/or a different length. The differently designed passages can be provided in the first and second regions of the fluid guide structure of the insert. The flow cross-sections of the passages can differ in terms of their shape and/or size, for example.

The passages may have a first plurality of passages and a second plurality of passages, wherein the first plurality of passages and the second plurality of passages differ in terms of their flow cross-sections, widths and/or lengths. Different groups of passages can therefore be provided, each with different flow characteristics. Instead of separate groups, the flow characteristics can also change continuously, for example along one edge of the through-opening. For example, it may be provided that the flow cross-sections and/or widths of the passages change in a direction perpendicular to the direction of flow of the fluid and/or remain constant in the direction of flow of the fluid and may decrease towards the center of the fluid guide structure.

The protrusions can form depressions on a first side of the insert facing away from the layer, wherein the depressions in the first region and in the second region each have an identical diameter and/or a different diameter and/or an identical width and/or a different width and/or an identical cross-sectional content and/or a different cross-sectional content and/or an identical cross-sectional shape and/or a different cross-sectional shape and/or an identical length and/or a different length. It is therefore clear that several parameters can be varied in order to achieve the desired different flow characteristics in the first region and in the second region.

In particular, at least one, several or all depressions can be channel-shaped. In this case, the protrusions are web-shaped. Channel-shaped or web-shaped does not necessarily mean that the structures are straight; curved channels or webs are also possible. At least two or all of the protrusions or depressions often extend essentially parallel to each other. In one embodiment, the fluid guide structure extends in a wave shape.

In some embodiments, at least one, several or all of the protrusions are nub-shaped. It is possible that the density of the nub-shaped protrusions in the first region is greater than in the second region. The density of the protrusions or the density of the nub-shaped protrusions should be understood to mean the relative proportion of the region covered by the protrusions and not necessarily just the number. The protrusions can also vary in size. A combination of differently shaped protrusions such as nub-shaped protrusions and bar-shaped protrusions is also possible.

The insert is often firmly connected to the layer, optionally by means of a materially bonded connection. For example, welded or bonded joints can be considered. Mechanical connections are also possible, which may be provided outside the section of the insert having protrusions.

Sometimes the insert in the region outside the fluid guide structure is essentially designed as a flat surface. The protrusions of the insert usually face the layer and, in particular, rest on the layer. The layer can have an essentially flat surface in the region of the fluid guide structure of the insert. In particular, the protrusions of the insert can rest on the flat surface of the layer. Furthermore, the insert can be arranged around the through-opening and, in particular, at least partially enclose the through-opening. Furthermore, the flow field can be at a distance from the fluid guide structure or directly adjacent to the fluid guide structure.

It may be provided that the through-opening has an edge, wherein a longitudinal direction of first passages or protrusions is aligned substantially perpendicular to a nearest region of the edge and/or a longitudinal direction of second passages or protrusions is aligned at an angle of between 0° and 90° to a nearest region of the edge.

The layer usually has at least two through-openings arranged next to each other, which are separated from each other by a region of the layer. In some embodiments, the insert is arranged at the at least two through-openings and has a fluid guide structure for both through-openings. It may be provided that both through-openings are designed as fluid inlets or that both through-openings are designed as fluid outlets, in particular for the same fluid. The insert can extend further between the at least two through openings. Optionally, the insert can extend along the edges of the two through-openings in the shape of a frame, a figure 8, or spectacles.

In some embodiments, the layer has a bead arrangement casted into the layer, which partially surrounds the at least one through-opening. This can refer to the region of the through-opening that is located adjacent to the fluid guide structure. The insert can be arranged on the bead arrangement, in particular in the region outside the fluid guide structure. It is possible that the bead arrangement runs between the through openings. The bead arrangement can be designed as a half bead or full bead, whereby a height of the bead arrangement and a height of the protrusions can be matched to each other, for example the heights are the same. In some embodiments, the insert can be arranged on the bead top of the bead arrangement.

The flow field usually has channel structures for guiding a reaction or product medium along the separator plate. A bead top of the bead arrangement and the channel structures of the flow field can be aligned in the same direction, optionally perpendicular to a plate plane of the layer, and formed into the separator plate, for example by embossing such as roll embossing, stroke embossing, hydroforming and/or deep drawing of the separator plate.

The bipolar plate can have an elastomer seal for sealing the through-opening, which is arranged on a first side of the insert facing away from the layer. The elastomer seal can be molded onto the insert and/or the layer. For example, the elastomer seal is designed as an elastomer bead or coating and is arranged on the layer and/or the insert. In particular, an elastomer seal can be applied continuously to the insert and the layer. It can also be used—as an alternative to another connection between these two elements or in addition to another connection—to connect the insert and the layer.

As already described above, the protrusions on the first side of the insert can form depressions, such as channels or dimples. In this case, the elastomer seal can be arranged at least in the depressions. On the rear side of the bipolar plate, i.e. a side of the bipolar plate facing away from the insert, the bead arrangement can form a receptacle for a further sealing element, for example an elastomer sealing element. The depressions of the insert can also be at least partially or completely filled with elastomer, thus forming a contact surface or stopper for the next seal on the side facing away from the bipolar plate.

The thickness of the insert may be no more than 70%, optionally no more than 30% of the thickness of the layer. Due to the reduced thickness of the insert, the protrusions and passages can be structured more finely than if they were formed in the layer.

It may be provided that the insert is made of metal, e.g. titanium or stainless steel, and/or the layer is made in sections, at least predominantly or completely, of metal, e.g. titanium or stainless steel. Other materials such as alloys are also possible and the present disclosure is not limited to a specific material of the layer. If the insert is made of metal, it can be produced by stamping, deep drawing or hydroforming. As an option, the insert and the layer can be made of the same or different materials. Additionally or alternatively, the insert can be formed separately from the layer and be made from a different material blank than the layer. The possibility to manufacture layer and insert separately increases the design options of both components.

According to a further aspect, a bipolar plate for an electrochemical system, in particular an electrolyser, is proposed. The bipolar plate comprises at least one layer and at least one insert. The layer comprises at least one through-opening as an inlet or outlet for a fluid and a flow field with an electrochemically active region. Here, the insert is arranged at the through-opening and comprises a fluid guide structure for guiding the fluid. The fluid guide structure of the insert is arranged between the flow field and the through-opening in the direction of flow of the fluid, so that the fluid is guided or flows from the through-opening through the fluid guide structure to the flow field or vice versa. The fluid guide structure of the insert has several protrusions and passages, with the passages each extending between adjacent protrusions and being designed to guide the fluid along the layer. At least two of the passages have a different flow cross-section and/or a different flow resistance and/or a different width and/or a different length.

The features described in connection with the bipolar plate according to the first aspect can be combined individually or in combination with the bipolar plate of the second aspect, without going beyond the scope of the present document.

According to a third aspect, an arrangement for an electrochemical system is proposed. The arrangement comprises a bipolar plate according to either of the two aspects described above, wherein the arrangement comprises a first cell frame and/or a membrane electrode unit and/or a second cell frame, and wherein the insert is arranged between the first cell frame and the layer and/or between the membrane electrode unit and the layer and/or between the second cell frame and the layer.

In one embodiment, the insert can be designed to support the first cell frame and/or the membrane electrode unit and/or the second cell frame, in particular in the region of the fluid guide structure. The cell frames can be made of a plastic and designed to seal regions of the bipolar plate, such as the flow field and/or the through-opening.

According to a fourth aspect of the present disclosure, an electrochemical system is proposed. The electrochemical system comprises a plurality of stacked bipolar plates of the type described above and/or a plurality of stacked arrangements of the type described above.

In one embodiment, in which the electrochemical system is an electrolyser, water can be the reaction medium, while hydrogen and oxygen are the product media. In a fuel cell system, hydrogen and oxygen or air are often the reaction media, while water is the product medium.

Examples of embodiments of the bipolar plate, the arrangement and the electrochemical system are shown in the attached figures and are explained in more detail in the following description.

### BRIEF DESCRIPTION OF THE FIGURES

FIG. 1 is a top view of a bipolar plate according to one embodiment.

FIG. 2 is a perspective view of a section D of the bipolar plate according to FIG. 1.

FIG. 3 is a perspective view of a region of the bipolar plate according to FIG. 1.

FIG. 4 is a section through a partial region A of the bipolar plate of FIG. 3.

FIG. 5 is a section through a further partial region B of the bipolar plate of FIG. 3.

FIG. 6 is a section through a further partial region C of the bipolar plate of FIG. 3.

FIG. 7 is a perspective view of a region of the bipolar plate according to FIG. 1.

FIG. 8 is a perspective view of a section along line A-A in FIG. 7.

FIG. 9 is a perspective view of a region of a bipolar plate according to a further embodiment.

FIG. 10 is a top view of a region of an insert according to a further embodiment.

FIG. 11 is a perspective view of a region of a bipolar plate according to a further embodiment.

FIG. 12 is a top view of a further insert and a sectional view along line B-B.

FIG. 13 is a perspective view of the insert of FIG. 12 and a perspective view of a section along line C-C.

FIG. 14 is a section through an arrangement of bipolar plate, insert and seal.

FIG. 15 is an exploded view of a single cell of an electrolyser with a conventional bipolar plate according to the prior art.

### DETAILED DESCRIPTION

Here and below, features that recur in different figures are denoted in each case by the same or similar reference numbers.

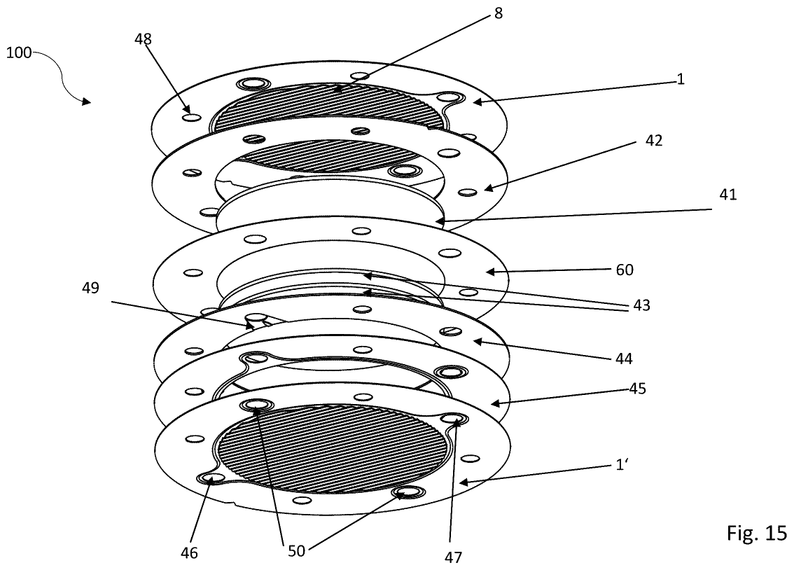

FIG. 15 shows an exploded view of an electrochemical single cell 100 according to the prior art, whereby the single cell 100 is part of an electrolyser in the example shown. Electrolysers typically comprise a large number of stacked individual cells 100. The single cell 100 shown comprises two bipolar plates 1 and 1′, two cell frames 42 and 44, a sealing layer 45 and a membrane electrode assembly 40 with media diffusion structures 41 and 43. Instead of the sealing layer 45, an elastomer seal can also be used, for example on the surface of the bipolar plate 1′ facing the cell frame 44; the cell frame 44 would then be directly adjacent to the bipolar plate 1′. For example, the media diffusion structure 43 comprises layers of carbon fleece, while the media diffusion structure 41 comprises metal, e.g. titanium. The bipolar plate 1 is arranged here, for example, on the anode side of the single cell 100. In the embodiment shown, the bipolar plate 1′is arranged on the cathode side of the single cell 100. The individual layers are pressed together to form a single cell 100. The individual layers each have fluid passages 46, 47, 50, arranged in alignment one above the other, for the inward and outward passage of water, oxygen and hydrogen, as well as positioning holes 48.

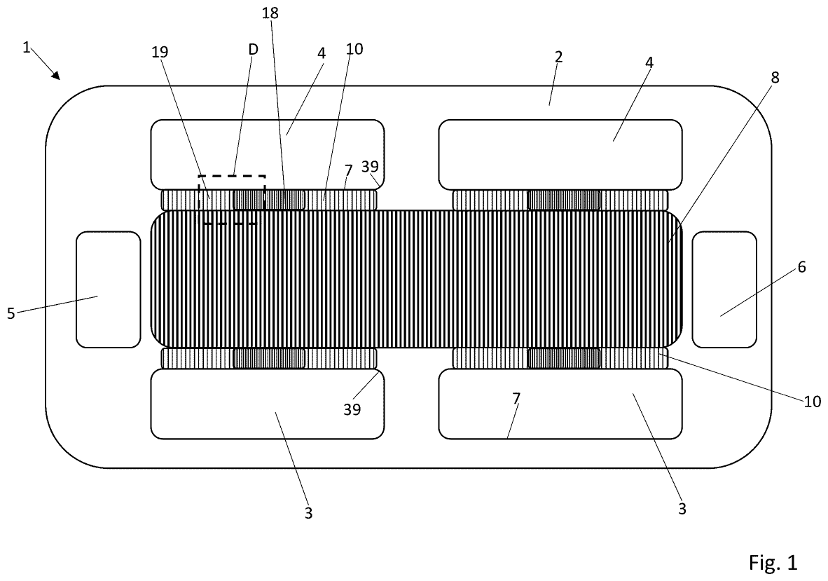

By projecting the cell frame 44 onto the separator plate 1′, a flow field of the bipolar plate 1′is defined in the region enclosed by the cell frame 44. By projecting the cell frame 42 onto the bipolar plate 1, a flow field 8 of the bipolar plate 1 is defined in the region enclosed by the cell frame 42. The cell frame 42 has distribution channels (not shown) for distributing the water that is fed in. The through-openings 46, 47 are in fluid communication with the flow field 8 so that a medium can be conducted from the through-opening 46 to the flow field 8 or from the flow field 8 to the through-opening 47. When a potential is applied, hydrogen (or oxygen) can be generated in the electrolyser from the supplied water. This can be discharged through the distribution channels 49 in the cell frame 44. It can then leave the cell through the through-openings 50. While the bipolar plates 1, 1′ shown in FIG. 15 have a round outer contour, other shapes are also possible. For example, the bipolar plates 1, 1′ can have a rectangular outer contour, possibly with rounded corners (see also FIG. 1).

As already indicated above, a pressure difference between the environment and the interior of the electrochemical cell 100 can be more than 20 bar. The pressure on the product side, for example the hydrogen side, is often up to 40 bar, while the pressure on the reactant side, for example the water side, is only up to 2 bar. It is therefore important that the individual regions of the bipolar plates 1, 1′ are sealed off from other regions of the bipolar plates and/or the environment.

FIG. 1 shows a top view of a highly schematized bipolar plate 1 according to the present disclosure. The bipolar plate 1 has at least one layer 2 and at least one insert 10.

The layer 2 is usually designed as a sheet metal layer and has a plurality of through-openings 3, 4, 5, 6, whereby each of the through-openings 4 and 6 is designed as an inlet and each of the through-openings 3 and 5 is designed as an outlet for a fluid, whereby water, hydrogen or oxygen, for example, can be considered as a fluid. The layer 2 also has a flow field 8 with an electrochemically active region. The flow field 8 has channel structures for guiding the fluid, such as a reaction or product medium, along the bipolar plate 1. The channel structures of the flow field 8 are usually, but not necessarily, designed as parallel protrusions.

The insert 10 is arranged between the flow field 8 and the through-opening 3, 4. The insert 10 is arranged at the through-opening 3, 4 and has a fluid guide structure 12 for guiding the fluid.

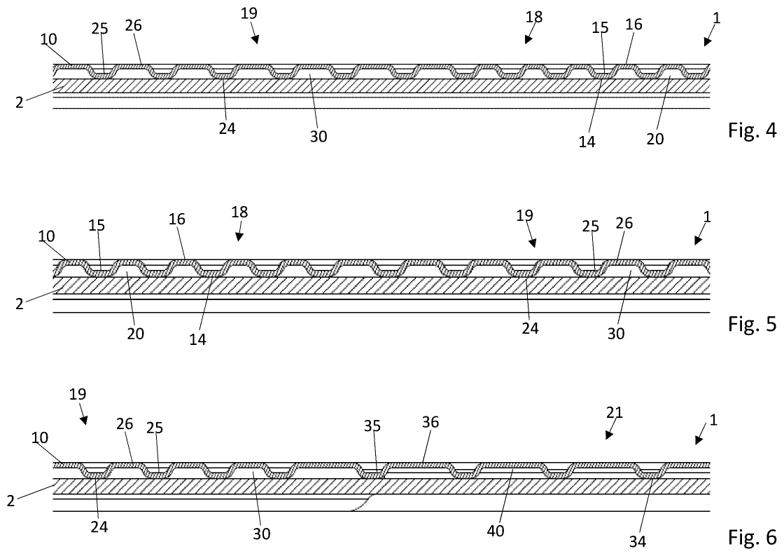

The insert 10 and the layer 2 can be made of the same or different materials. For example, metals such as titanium or stainless steel are possible. Other materials such as alloys are also possible. Additionally or alternatively, the insert 10 can be formed separately from the layer 2 and be made from a different material blank than the layer 2. The insert 10 can have a thickness of at most 70%, optionally at most 30% of a thickness of the layer 2. Furthermore, the insert 10 can be firmly connected to the layer 2, for example by a materially bonded connection. In this way, the insert 10 can be connected to the layer 2 by a welded or glued joint. As shown in FIGS. 1-9, the protrusions 14, 24 of the insert 10 face the layer 2 and rest on the layer 2. The layer 2 may have a substantially flat surface in the region of the fluid guide structure 12 of the insert 10, with the protrusions 14, 24 of the insert 10 resting on the flat surface of the layer 2.

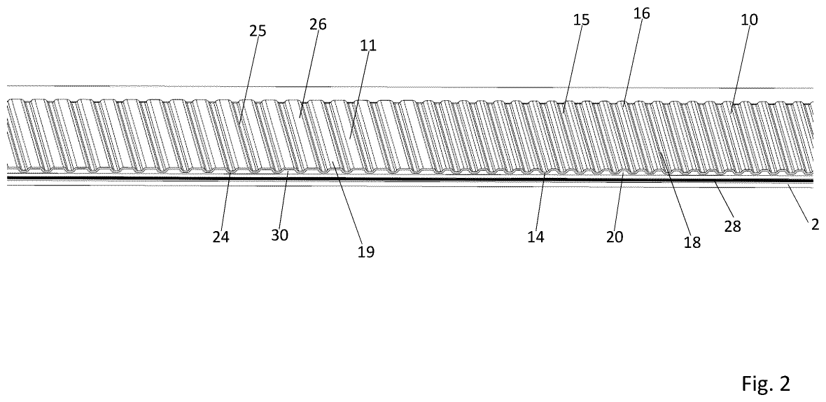

In the embodiment examples of FIGS. 2-9, the insert 10 is arranged at the through-opening 3, 4 and further arranged around the through-opening 3, 4. The insert 10 often encloses the through-opening 3, 4 at least partially, optionally completely.

In order to clarify the structure of the insert 10, FIGS. 2-10, which show various parts and aspects of the insert 10, are also described below.

The fluid guide structure 12 of the insert 10 has several protrusions 14, 24, 34 and is arranged in the direction of flow of the fluid between the flow field 8 and the through-opening 3, 4. This allows the fluid to flow from the through-opening 4 as an inlet through the protrusions 14, 24, 34 of the fluid guide structure 12 to the flow field 8. Furthermore, the fluid can flow from the flow field 8 through the fluid guide structure 12 and between the protrusions 14, 24, 34 of the insert 10 to the through-opening 3 as an outlet.

The fluid guide structure 12 comprises a first region 18 and a second region 19, which are arranged next to each other in the direction of flow of the fluid. Optionally, a third region 21 can also be provided, which is arranged next to the first region 18 or the second region 19 in the direction of flow of the fluid. The regions 18, 19, 21 extend in the direction of flow of the fluid from an end of the fluid guide structure 12 facing the through-opening 3, 4 to an end of the fluid guide structure 12 facing the flow field 8. The aforementioned regions 18, 19, 21 differ from each other in terms of their flow cross-sections and/or flow resistances.

The protrusions 14, 24 are at different distances from each other and/or are arranged at different densities, so that a flow cross-section in the first region 18 is smaller than a flow cross-section in the second region 19 and/or a flow resistance in the first region 18 is greater than a flow resistance in the second region 19. In addition, the protrusions 24, 34 can each have different distances from one another and/or are arranged at different densities, so that a flow cross-section in the second region 19 is smaller than a flow cross-section in the third region 21 and/or a flow resistance in the second region 19 is greater than a flow resistance in the third region 21. In the embodiment example shown, the protrusions 14, 24, 34 are identically shaped in the regions 18, 19, 21. Alternatively, they can also be shaped differently in each of the regions 18, 19, 21.

In addition, the fluid guide structure 12 of the insert 10 has a plurality of passages 20, 30, 40, each extending between adjacent protrusions 14, 24, 34 and configured to guide the fluid along the layer 2. The passages 20 in the first region 18, the passages 30 in the second region 19 and the passages 40 in the third region 21 have a different flow cross-section and/or a different flow resistance. In particular, the flow cross-sections of the passages 40 are larger than those of the passages 30, whereby the flow cross-sections of the passages 30 are in turn larger than those of the passages 20. In addition, the passages 20, 30, 40 in the various regions 18, 19, 21 each have a different width and/or a different length.

By using the passages 20, 30, 40 or protrusions 14, 24, 34 of the fluid guide structure 12, which vary in terms of flow resistance or flow cross-section, the flow behavior of the fluid can be specifically influenced. Thus, the fluid flow resistance at the through-opening 3, 4 typically decreases from the corner region 39 towards the center of the through-opening or increases from its center towards the corner regions 39. If the flow resistance of the fluid guide structure 12 is greater in a region adjacent to the center of the through-opening 3, 4, namely the first region 18, than in the second region 19 and the third region 21, the flow distribution and fluid flow through the through-opening 3, 4 can be made more uniform.

The protrusions 14, 24, 34 form depressions 15, 25, 35 on a first side 11 of the insert 10 facing away from the layer 2, wherein the depressions 15 in the first region 18, the depressions 25 in the second region 19 and the depressions 35 in the third region 21 each have the same diameter, the same width, the same cross-sectional content and the same cross-sectional shape. Alternatively, the stated sizes in the regions 18, 19, 21 can also deviate from each other. Accordingly, the passages 20, 30, 40 form complementarily shaped webs 16, 26, 36 on the first side 11 of the insert 10 facing away from the layer 2, which webs have different widths and/or lengths in the regions 18, 19, 21.

In some embodiments, it is provided that the flow cross-sections and/or widths of the passages 20, 30, 40 vary continuously in a direction perpendicular to the direction of flow of the fluid and may decrease towards the center of the through-opening 3, 4 or the fluid guide structure 12, while remaining substantially constant in the direction of flow of the fluid.

The protrusions 14, 24, 34 of FIGS. 1-9 and 11 are all designed as elongated webs. Accordingly, the depressions 15, 25, 35 associated with the protrusions 14, 24, 34 are designed as channel-shaped grooves. The fluid guide structure 12 extends along the through-opening 3, 4 in an undulating manner through the web-shaped protrusions 14, 24, 34 and the passages 20, 30, 40 located between them. However, differently shaped protrusions or depressions are also conceivable.

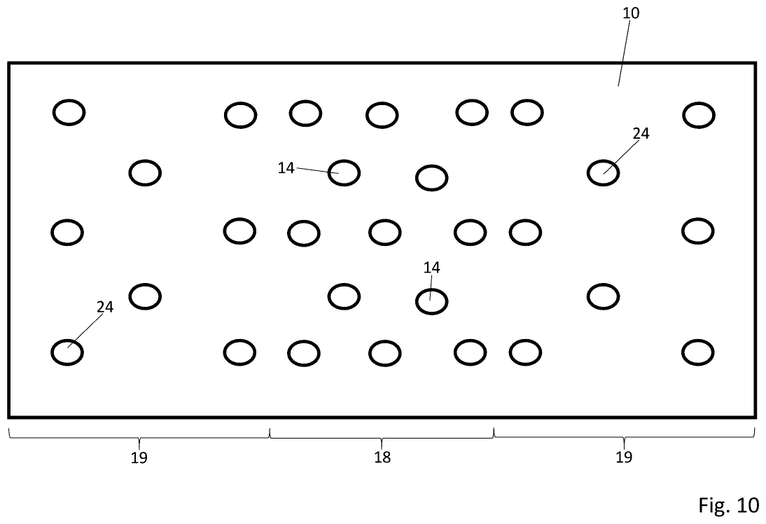

FIG. 10 shows an alternative embodiment of the insert 10, in which the protrusions 14, 24 are designed as nubs formed into the insert. FIG. 10 shows a top view of the side of the insert facing the layer 2 and arranged on the layer 2. A density of the protrusions 14 in the first region 18 of the insert 10 is higher than a density of the protrusions 24 in the second region 19 of the insert. Specifically, this is realized by a larger number of nubs. Additionally or alternatively, the nubs in the first region 18 can also be larger than the nubs in the second region, as a result of which the flow resistance in the first region 18 is greater than in the second region 19 or the flow cross-section in the second region 19 is greater than in the first region 18.

The channel structures of the flow field 8 are usually, but not necessarily, designed as parallel protrusions whose length in the direction of flow of the fluid is often significantly longer, for example at least 5 times longer, than the length of the protrusions 14, 24, 34 of the fluid guide structure 12. The layer 2 often has a bead arrangement 9 formed into the sheet material of the layer 2, which partially surrounds the through-opening 3, 4, namely in the region outside the fluid guide structure 12. Together, the bead arrangement 9 and the fluid guide structure 12 surround the through-opening 3, 4. The bead arrangement 9 and the channel structures of the flow field 8 are generally formed into the layer 2 by embossing, deep drawing or hydroforming and are aligned in the same direction, optionally perpendicular to a plane of the layer 2. The bead arrangement 9 and the channel structures of the flow field 8 are therefore integral components of layer 2. The plane of layer 2 is an extended flat surface without embossing; the plane of layer 2 can, for example, extend adjacent to the insert 10.

In FIGS. 1, 3 and 9, the through-openings 3, 4 are rectangular with rounded corners. The through-opening 3, 4 has an edge 7 which delimits an edge region 17 of the layer 2 around the through-opening 3, 4, and a longitudinal direction of the passages 20, 30 is oriented substantially perpendicular to the edge 7 or a nearest region of the edge 7. In a corner region 39 of the through-opening 3, 4, a longitudinal direction of passages 30, 40 is aligned at an angle of between 0° and 90° to a nearest region of the edge 7. The fluid guide structure 12 adjoins the through-opening 3, 4, more precisely the edge region 17 of the layer 2.

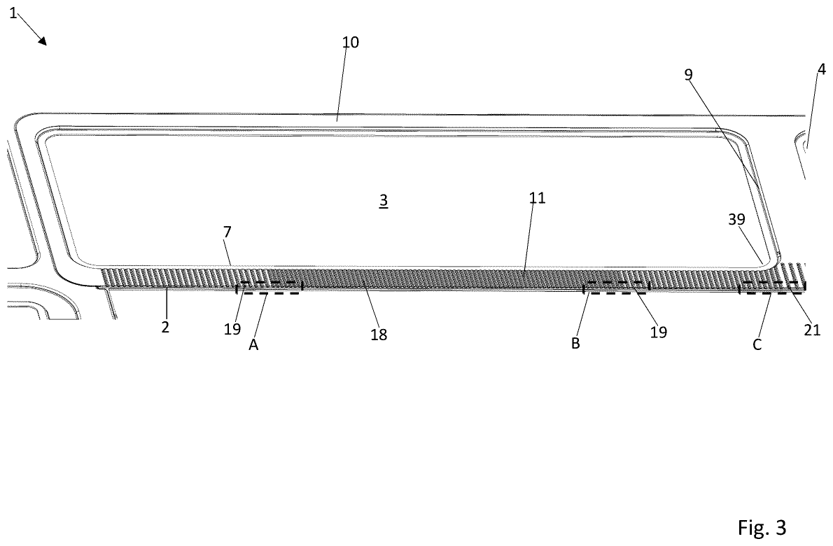

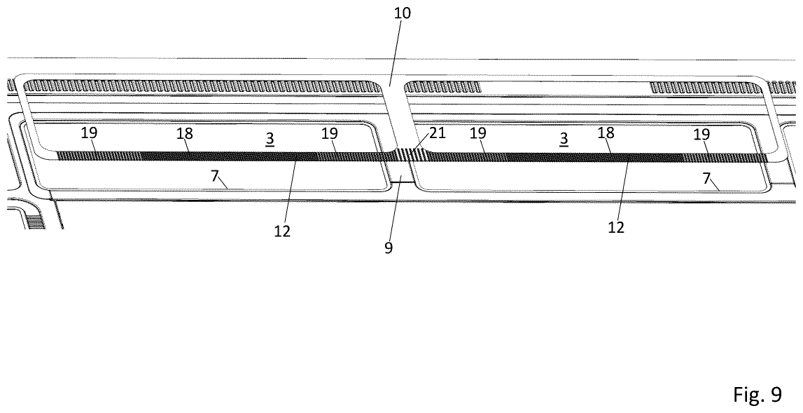

In the embodiment example of FIG. 1, a total of four inserts 10 are shown, each of which is arranged at a through-opening 3, 4 of the layer. The number of inserts 10 can be smaller than the number of through-openings 3, 4. In the embodiment examples of FIGS. 3 and 9, at least two through-openings 3, 4 arranged next to each other or adjacent to each other share an insert 10. In this case, a single insert 10 is arranged at at least two through-openings 3, 4, the insert having a fluid guide structure 12 for both through-openings 3, 4. It may be provided that the insert 10 extends between the at least two through-openings 3, 4. In FIGS. 3 and 9, the insert 10 extends in a frame-like, 8-shaped or spectacle-shaped manner along the edges 7 of the two through-openings 3.

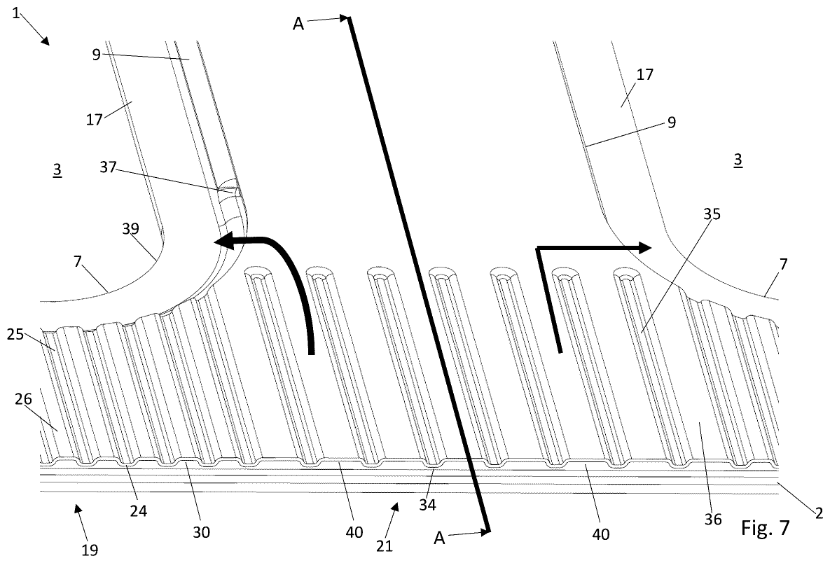

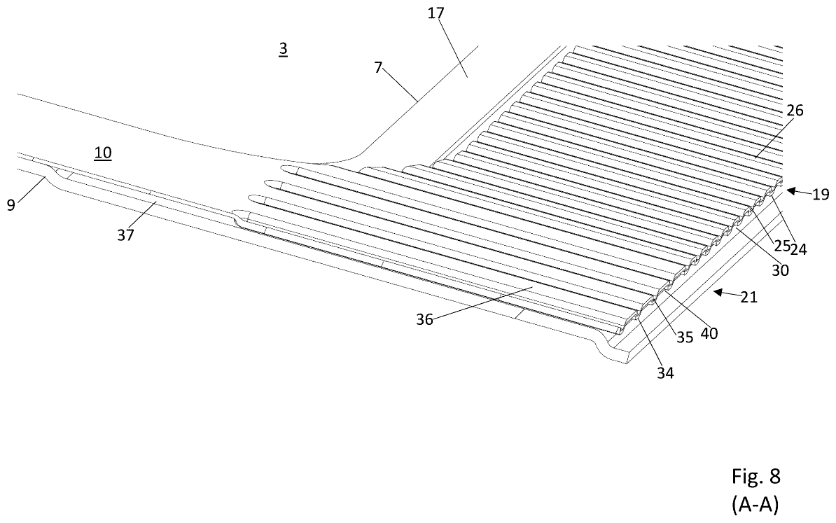

The bead arrangement 9 can run between two adjacent through-openings 3, 4. The term bead or bead arrangement 9 is used here in particular to describe the shape of the bead; it can be associated with an element that has only a minimal or a significant elastic component, which depends in particular on the selected material and its material strength. For example, the insert 10 can be arranged on the bead top of the bead arrangement 9. An end face of the bead arrangement 9 faces the third region 21 of the fluid guide structure 12, wherein a fluid channel 37 is formed between the end face of the bead arrangement 9 and the protrusions 34 of the third region 21, which fluid channel 37 extends at an angle, e.g. perpendicularly, to the protrusions 34. The fluid channel 37 fluidically connects the through-opening 3, 4 with the passages 40 in the third region 21 of the fluid guide structure 12. In FIG. 7, the direction of fluid flow is indicated by arrows. As can be seen from FIG. 7, the fluid channel 37 and the passages 40 in the third region 21 enable a fluid flow in the region of the layer 2 between the through-opening 3, 4, so that fluid can also flow there between the through-opening 3, 4 and the flow field 8. FIG. 8 also shows that the protrusions 34 and the passages 40 in the third region 21 are longer than the protrusions 24 and the passages 30 in the second region 19.

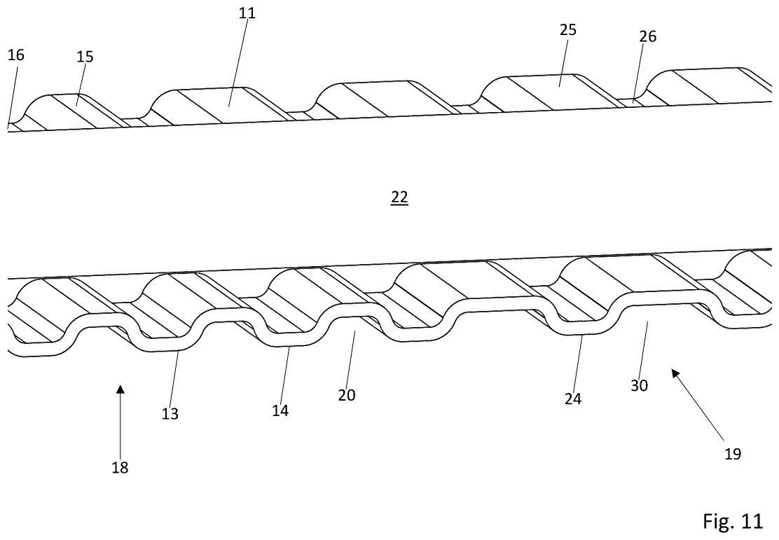

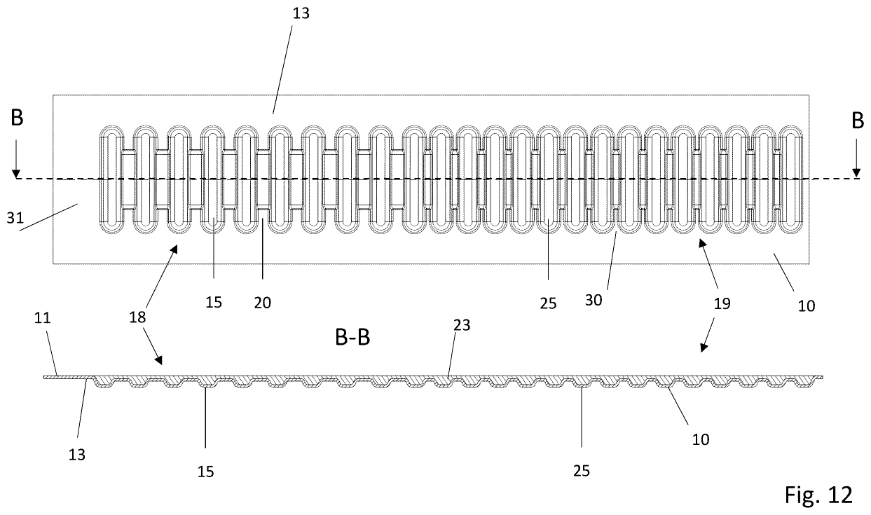

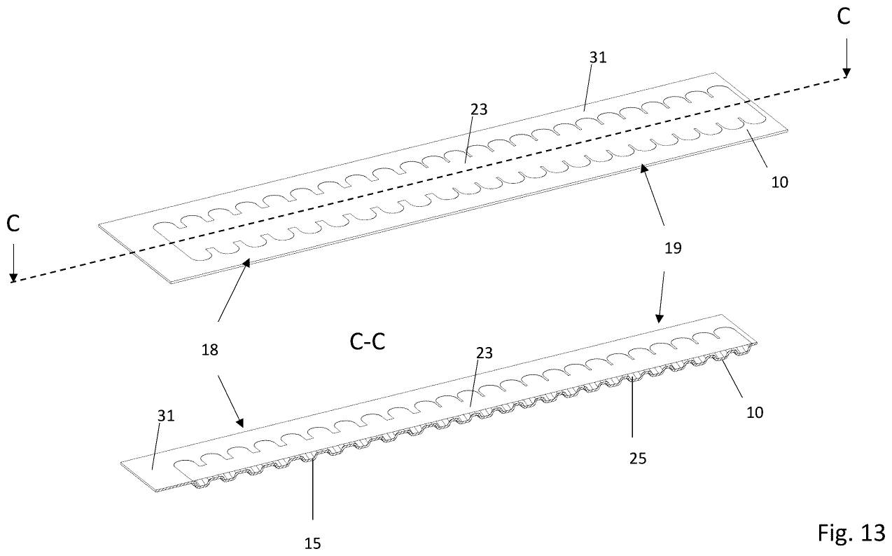

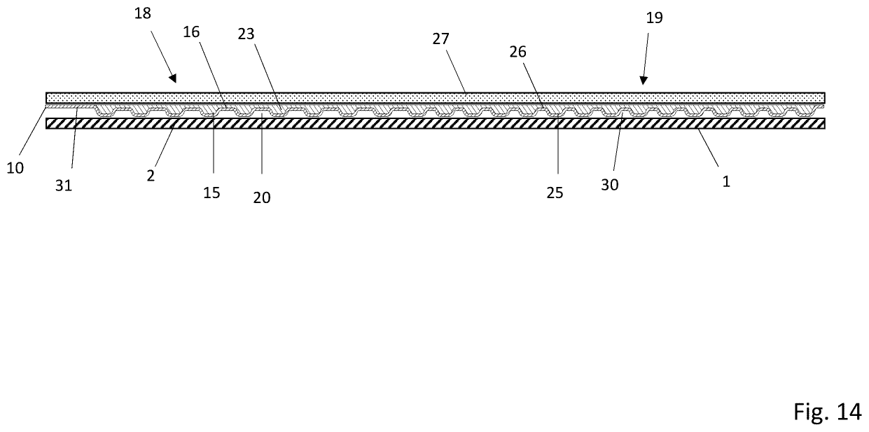

Typically, the bipolar plate 1 comprises an elastomer seal 22 for sealing the through-opening 3, 4, which is arranged on a first side 11 of the insert 10 facing away from the layer 2. The elastomer seal 22 can be arranged in the depressions 15, 25 of the insert 10 or can be molded onto the insert 10 there. The elastomer seal 22 can be designed in such a way that it forms a flat surface on the side facing away from the layer 2. As shown in FIG. 11, the elastomer seal 22 can extend only over a section of the first, second and possibly third regions, in particular with respect to the direction of fluid flow. However, it can also cover the entire region provided with protrusions 14, 24, 34 or extend beyond it. The combination of insert 10 with elastomer seal 22 allows overlying components in this region of the fluid guide structure 12 to be supported, which leads to improved scaling to the mating components such as the MEA, cell frame, etc. For this purpose, an advantageous design of the insert 10 is the embodiment of the insert 10 shown in FIGS. 12 to 14 with depressions 15 and 25 completely filled with elastomer 23. The elastomer 23 makes the insert 10 incompressible or increases the incompressibility of the insert 10, so that the insert 10 is suitable as a stopper element for overlying elements.

In FIG. 12, the insert is shown from the second side 13, but the elastomer 23 injected into the depressions 15, 25 from the first side 11 can be seen in the section in FIG. 12. The fact that the insert 10 in these cases is completely, often exactly completely filled with elastomer 23 in the depressions 15, 25 means that it can, for example, form a contact surface or stopper for a further elastomer seal 22 or 27. The insert 10 can have an edge section 31 which encloses the depressions 15, 25 at least in sections, so that the depressions 15, 25 extend within a region defined by the edge section 31, for example in the shape of a trough or chamber. The elastomer 23 can be flush with the edge section 31 and arranged in the depressions 15, 25 and sometimes also on the webs 16, 26. The edge section 31 can therefore be slightly higher than the webs 16, 26, or the webs 16, 26 can be embossed slightly lower than the edge section 31. Other types of seals around the through-openings are also possible, for example the bipolar plate 1 in layer 2 could also be provided with a beaded seal around the through-openings. In order to act as a stopper, it is advantageous if the elastomer 23 is flush with the edges of the depressions 15, 25 or the edge section 31. The elastomer 23 should neither protrude nor be too low. This ensures the main sealing function and increases the lifetime of the components.

On the rear side of the bipolar plate 1, i.e. a side of the bipolar plate 1 facing away from the insert 10, the bead arrangement 9 can form a receptacle for a further sealing element, for example an elastomeric sealing element 28.

As in FIG. 15, the bipolar plate 1 can be part of an arrangement for an electrochemical system. In addition to the bipolar plate 1, the arrangement comprises a first cell frame 42 and/or a membrane electrode unit 40 and/or a second cell frame 44. The insert 10 is then arranged between the first cell frame 42 and the layer 2 and/or between the membrane electrode unit 40 and the layer 2 and/or between the second cell frame 44 and the layer 2. An electrochemical system according to the present disclosure then comprises a plurality of stacked bipolar plates 1 and/or a plurality of the stacked arrangements.

### LIST OF REFERENCE SIGNS

1 bipolar plate
1′ bipolar plate
2 layer
3 through-opening
4 through-opening
5 through-opening
6 through-opening
7 edge
8 flow field
9 bead arrangement
10 insert
11 first side
12 fluid guide structure
13 second side
14 protrusion in the first region
15 depression in the first region
16 web in the first region
17 edge region
18 first region
19 second region
20 passage in the first region
21 third region
22 elastomer seal
23 elastomer filling
24 protrusion in the second region
25 depression in the second region
26 web in the second region
27 seal
28 elastomeric sealing element
30 passage in the second region
31 edge portion
34 protrusion in the third region
35 depression in the third region
36 web in the third region
37 fluid channel
39 corner region
40 passage in the third region
41 media diffusion structure
42 cell frame
43 media diffusion structure
44 cell frame
45 sealing layer
46 through-opening for fluid
47 through-opening for fluid
48 positioning hole
49 hydrogen distribution channels
50 hydrogen through-openings
60 membrane electrode assembly
100 electrochemical cell

1. A bipolar plate for an electrochemical system, comprising at least one layer and at least one insert, the layer comprising
at least one through-opening as an inlet or outlet for a fluid, and
a flow field with an electrochemically active area,
wherein the insert is arranged at the through-opening and comprises a fluid guide structure for guiding the fluid,
wherein the fluid guide structure of the insert has a plurality of protrusions and is arranged in a direction of flow of the fluid between the flow field and the through-opening, so that the fluid is guided from the through-opening through the fluid guide structure between the plurality of protrusions to the flow field or vice versa,
wherein the fluid guide structure comprises a first region and a second region, which are arranged next to each other in the direction of flow of the fluid,
wherein protrusions of the plurality of protrusions in the first region and in the second region each have different distances from one another and/or are arranged at different densities and/or are shaped differently, so that a flow cross-section in the first region is smaller than a flow cross-section in the second region and/or a flow resistance in the first region is greater than a flow resistance in the second region.

2. The bipolar plate according to claim 1, wherein the fluid guide structure of the insert has a plurality of passages which each extend between adjacent protrusions of the plurality of protrusions and are designed to guide the fluid along the layer, wherein at least two of the plurality of passages have a different flow cross-section and/or a different flow resistance and/or a different width and/or a different length.

3. The bipolar plate according to claim 2, wherein the flow cross-sections and/or widths of the plurality of passages change in a direction perpendicular to the direction of flow of the fluid and/or remain constant in the direction of flow of the fluid and decrease towards a center of the fluid guide structure.

4. The bipolar plate according to claim 1, wherein the protrusions form depressions on a first side of the insert facing away from the layer, wherein the depressions in the first region and in the second region each have an identical diameter and/or a different diameter and/or an identical width and/or a different width and/or an identical cross-sectional content and/or a different cross-sectional content and/or an identical cross-sectional shape and/or a different cross-sectional shape and/or an identical length and/or a different length.

5. The bipolar plate according to claim 1, wherein the protrusions are nub-shaped, wherein a density of the nub-shaped protrusions is greater in the first region than in the second region.

6. The bipolar plate according to claim 1, wherein the insert is firmly connected to the layer by a materially bonded connection.

7. The bipolar plate according to claim 1, wherein the protrusions of the insert face the layer and rest on the layer.

8. The bipolar plate according to claim 1, wherein the insert is arranged around the through-opening and at least partially encloses the through-opening.

9. The bipolar plate according to claim 1, wherein the layer has a substantially flat surface in the region of the fluid guide structure of the insert, and the protrusions of the insert rest on the substantially flat surface of the layer.

10. The bipolar plate according to claim 1, wherein the through-opening has an edge, and a longitudinal direction of first passages is aligned substantially perpendicular to a nearest region of the edge and/or a longitudinal direction of second passages is aligned at an angle between 0° and 90° to a nearest region of the edge.

11. The bipolar plate according to claim 1, wherein the layer has a bead arrangement formed into the layer, which partially surrounds the through-opening.

12. The bipolar plate according to claim 11, wherein the layer has at least two through-openings arranged next to one another, wherein the bead arrangement extends between the through-openings, wherein the insert is arranged at both of the at least two through-openings and has the fluid guide structure for a first through-opening of the at least two through-openings and a second fluid guide structure for a second through-opening of the at least two through-openings.

13. The bipolar plate according to claim 12, wherein the insert extends between the at least two through-openings and is arranged on the bead arrangement, and extends in a frame-shaped, 8-shaped or spectacle-shaped manner along edges of the two through-openings.

14. The bipolar plate according to claim 12, wherein both through-openings are designed as fluid inlets or fluid outlets.

15. The bipolar plate according to claim 1, comprising an elastomer seal for sealing the through-opening, which is arranged on a first side of the insert facing away from the layer.

16. The bipolar plate according to claim 15, wherein the protrusions on the first side of the insert form recesses and the elastomer seal is arranged at least in the recesses.

17. The bipolar plate according to claim 1, wherein a thickness of the insert is at most 70% of a thickness of the layer.

18. A bipolar plate for an electrochemical system, comprising at least one layer and at least one insert, the layer comprising
at least one through-opening as an inlet or outlet for a fluid, and
a flow field with an electrochemically active area,
wherein the insert is arranged at the through-opening and comprises a fluid guide structure for guiding the fluid,
wherein the fluid guide structure of the insert is arranged between the flow field and the through-opening in a direction of flow of the fluid, so that the fluid is guided from the through-opening through the fluid guide structure to the flow field or vice versa,
wherein the fluid guide structure of the insert has a plurality of protrusions and passages, wherein the passages each extend between adjacent protrusions and are designed to guide the fluid along the layer,
wherein at least two of the passages have a different flow cross-section and/or a different flow resistance and/or a different width and/or a different length.

19. An arrangement for an electrochemical system, comprising the bipolar plate according to claim 1, wherein the arrangement comprises a first cell frame and/or a membrane electrode unit and/or a second cell frame, and wherein the insert is arranged between the first cell frame and the layer and/or between the membrane electrode unit and the layer and/or between the second cell frame and the layer.

20. An electrochemical system, comprising a plurality of stacked bipolar plates according to claim 1.
